(19) United States
(12) Patent Application Publication
(10) Pub. No.: US 2014/0352728 A1
(43) Pub. Date: Dec. 4, 2014

(54) METHOD FOR MONITORING THE OPERATION OF A LIQUID FOOD PROCESSING SYSTEM

(71) Applicant: Tetra Laval Holdings & Finance S.A., Pully (CH)

(72) Inventor: Cecilia Svensson, Hassleholm (SE)

(21) Appl. No.: 14/367,890

(22) PCT Filed: Dec. 14, 2012
(86) PCT No.: PCT/EP2012/075560

§ 371 Date: Jun. 20, 2014

(30) Foreign Application Priority Data
Dec. 22, 2011 (SE) 1151265-4

(51) Int. Cl. A23C 7/02; B08B 3/08; B08B 9/032

(52) U.S. Cl. CPC A23C 7/02; B08B 9/032; B08B 3/08
USPC 134/18; 99/452; 134/166 C; 134/56 R

(57) ABSTRACT

A method for monitoring the operation of a liquid food processing system is provided. The method comprises the steps of initiating a fluid flow through at least one section of said food processing system; and determining a pressure difference across said at least one section during said fluid flow for monitoring removal or build-up of deposits, the removal or build-up being caused by said fluid flow.

### TECHNICAL FIELD

The present invention relates to a method of monitoring the operation of a liquid food processing system. More particularly, the present invention relates to a method for monitoring and optimizing operation parameters of a liquid food processing system.

### BACKGROUND

A liquid food processing system, such as a dairy system, includes a plurality of food processing equipments arranged in several sections wherein each section is designed to provide a specific treatment of the food. For example, a dairy system may include a separating section, a filtering section, a homogenisation section, and a heat treatment section such as ultra high temperature (UHT) treatment.

When liquid food is transported through the different sections soil layers are known to be deposited on the interior walls of the equipment. Such deposition, commonly denoted as fouling, affects the performance of the equipment and must be removed at regular intervals in order to maintain high performance of the food processing system.

The provision of fouling may be monitored and measured as described in U.S. Pat. No. 4,521,864, in which a method for determining the fouling thickness by measuring the relationship between fluid flow velocity and pressure difference is described.

The traditional way of cleaning equipment, which has previously been done by disconnecting the fouled equipment and reconnect it after cleaning, has in many applications been replaced by a so called cleaning-in-place (CIP) process. In such method the food to be processed is prevented from flowing through the particular section to be cleaned, and the food is redirected after cleaning of the equipment As the cleaning process is done without dismounting the equipment the overall running time of the processing system is increased significantly.

In food processing applications the CIP process is a sequential process in which chemical agents are introduced into the equipment and upon flowing through the equipment the agents will dissolve the fouling or remove it by mechanical impact. For this, the chemical agent is usually switched between an acid detergent and an alkaline detergent for a number of cycles, where the flowing time for each detergent is varied in order to provide sufficient cleaning and removal of the fouling.

Although the known CIP-precesses provide sufficient cleaning of the processing equipment, there are always high demands on minimizing the required cleaning time. Therefore it is of high importance to monitor the operation of a liquid food processing system, as well as to improve cleaning of such liquid food processing systems.

### SUMMARY

It is, therefore, an object of the present invention to overcome or alleviate the above described problems.

The basic idea is to provide a method for monitoring the operation of a liquid food processing system in order to determine the removal or build-up of deposits.

Further, an idea is to monitor the cleaning process such that the operating parameters of a CIP cycle may be adjusted in order to obtain maximum cleaning in minimum time.

A further idea is to measure the pressure difference caused by the fouling, and continuously monitor the pressure difference decrease as the cleaning proceeds.

A yet further idea is to compare the measured pressure difference with a reference value for creating a pressure difference ratio.

A yet further idea is to provide a method for dividing the food processing system into at least one CIP circuit, and performing and monitoring cleaning of that particular circuit.

According to a first aspect, a method for monitoring the operation of a liquid food processing system is provided. The method comprises the steps of initiating a fluid flow through at least one section of said food processing system: and determining a pressure difference across said at least one section during said fluid flow for monitoring removal or build-up of deposits, said removal or build-up being caused by said fluid flow.

The method may further comprise the step of comparing said determined pressure difference with a reference value.

The method may further comprise the step of dividing said determined pressure difference with said reference value for calculating a pressure difference ratio.

Said reference value may represent the pressure difference across said section when said section is considered as being sufficiently clean.

Said pressure difference may be determined continuously during said fluid flow.

Said determined pressure difference may comprise a value representing the pressure difference derivative, and the method may further comprise the step of comparing said value with a pressure difference reference derivative. The pressure difference reference value may be calculated by measuring a volume flow of said fluid flow through said section when being sufficiently clean, and multiplying the square of said volume flow with a predetermined constant.

The method may further comprise the step of dividing said liquid food processing system into at least two sections, wherein said pressure difference is determined across each section during said fluid flow.

According to a second aspect, a method for optimizing the operation of a liquid food processing system is provided. The method comprises the steps of monitoring said operation according to the first aspect, and stopping said fluid flow when the determined pressure difference equals a predetermined value.

Said fluid flow may be provided by initiating a cleaning step including flowing a cleaning agent through a cleaning-in-place circuit of said liquid food processing system, wherein the method may further comprise the step of changing at least one cleaning step parameter during said cleaning step.

Said at least one cleaning step parameter may be selected from the group consisting of: cleaning step duration, cleaning agent temperature, cleaning agent flow, and cleaning agent concentration.

The method may further comprise the step of initiating a subsequent cleaning step after stopping the monitored cleaning step. Said subsequent cleaning cycle may be a rinsing step, a dosing of alkaline detergent step, a circulation of alkaline detergent step, a dosing of acid detergent step, or a circulation of acid detergent step.

The method of monitoring said operation may be repeated for said subsequent cleaning step.

Said fluid flow may be provided by initiating a liquid product flow through said liquid food processing system, wherein the method may further comprise the step of changing at least one product flow parameter during said product flow.

The method may further comprise the step of initiating a rinsing step after stopping the monitored liquid product flow.

The method may further comprise the step of initiating a cleaning-in-place cycle after said rinsing step.

The method may further comprise the step of identifying the product being processed by said liquid food processing system, and wherein said predetermined value of the pressure difference is associated with said product.

Said liquid food processing system may be a dairy system.

According to a third aspect, a liquid food processing system is provided. The food processing system comprises at least one section through which liquid food products are flowing during food processing and causing build-up of deposits within said section, and at least one sensor configured to determine a pressure difference across said at least one section for monitoring removal or build-up of said deposits.

The at least one sensor may include two sensors arranged at a first end and a second end of said section.

The food processing system may further comprise a determining unit connected to said sensors and being configured to calculate said pressure difference.

Further, the food processing system may comprise a calculating unit configured to receive said determined pressure difference and to compare said pressure difference with a reference value.

The food processing system may further comprise a cleaning-in-place circuit for removing said deposits by initiating a cleaning cycle including at least one step of flowing cleaning fluid through said at least one section.

The food processing system may further comprise a controller configured to receive said determined pressure difference, wherein said controller is further connected to a pump and/or heating units of said sections and/or a feeding tank for changing the operating parameters of said pump and/or said heating units depending of the received pressure difference.

The controller may be connected to a remote reference memory storing data representing said operating parameters as a function of pressure difference.

The remote reference memory may be connected to several food processing systems such that each processing system receives data representing said operating parameters from said reference memory.

According to a fourth aspect, a kit of parts for installation in a liquid food processing plant is provided. The kit of parts comprises a volume flow sensor for measuring a volume flow of a reference fluid flow, a calculator for determining a reference pressure difference from said measured volume flow, a pressure difference sensor for measuring a pressure difference of an actual fluid flow, and a controller for comparing said measured pressure difference with said reference pressure difference for monitoring removal or build-up of deposits during said actual fluid flow.

Liquid food product is defined as a food product being possible to pump through a food processing line. Hence, liquid food product includes food products having different viscosities as well as arbitrary amount of solid content. Liquid food product is thus defined as a common term for drinks, milk, juice, soups, puree, baby food, etc.

### BRIEF DESCRIPTION OF DRAWINGS

The above, as well as additional objects, features, and advantages of the present invention, will be better understood through the following illustrative and non-limiting detailed description of preferred embodiments of the present invention, with reference to the appended drawings, wherein:

FIG. 1 is a process scheme for a food processing system utilizing a method according to an embodiment;

FIG. 2 is a diagram showing removal of fouling as a function of cleaning parameters for a first section of a food processing system;

FIG. 3 is a diagram showing removal of fouling as a function of cleaning parameters for a second section of a food processing system; and

FIG. 4 is a process scheme of a food processing system according to an embodiment.

### DETAILED DESCRIPTION

As will be further described below, a method for monitoring cleaning-in-place parameters of a food processing system is provided which method includes the step of measuring the pressure difference during the cleaning process. The measured pressure difference is correlated to the degree of fouling, as a reduction in pipe diameter caused by the fouling increases the pressure difference over the equipment.

In order to completely understand the relationship between pressure difference and deposits such as fouling some basic theory is presented which is relevant when considering food product flowing through pipes and conduits of a processing system such as a dairy.

In a closed system the mass flow \dot{m} is constant:

$$\dot{m} = {ρ}_{1} \cdot {v}_{1} \cdot {A}_{1} = {ρ}_{2} \cdot {v}_{2} \cdot {A}_{2} [ \frac{kg}{s} ] .$$

where ρ is the density of the fluid, v is the velocity of the fluid, and A is the flow area.

If the density ρ is constant the volume flow \dot{V} is described by:

$$\dot{V} = {v}_{1} \cdot {A}_{1} = {v}_{2} \cdot {A}_{2} [ \frac{{m}^{3}}{s} ]$$

Bernoulli's equation reads:

$${p}_{1} = ρ \cdot g \cdot {h}_{1} + \frac{{v}_{1}^{2}}{2} \cdot ρ + Δ {p}_{pump} = ρ \cdot g \cdot {h}_{2} + \frac{{v}_{2}^{2}}{2} \cdot ρ + Δ {p}_{f 12} ,$$

where

p=pressure,

g=gravity,

h=height,

v=flow velocity,

ρ=density,

Δpₚᵤₘₚ=Pressure added from a pump, and

Δp_{f12}=pressure losses due to friction.

Δp_{f12} can be calculated from the following formula, in which λ denotes the pipe friction coefficient, i.e. a function of Reynold's number and roughness of the solid surface, ξ is the single resistance due to valves, bends, etc., and Dᵢ is the inner diameter of the pipe:

$$Δ {p}_{f 12} = \sum [ λ \cdot \frac{1}{{D}_{i}} + \sum ξ ] \cdot \frac{{v}^{2}}{2} \cdot ρ .$$

If the temperature, density, and the viscosity of the fluid are assumed to be constant the equation above could be simplified according to the following, which is valid for the pressure difference in a situation when fluid is circulating during cleaning:

Δp=K_{syst}·\dot{V}², where K_{syst} is a constant.

Hence, the pressure difference over a specific process path may be determined by multiplying a measured volume flow with a predetermined system constant.

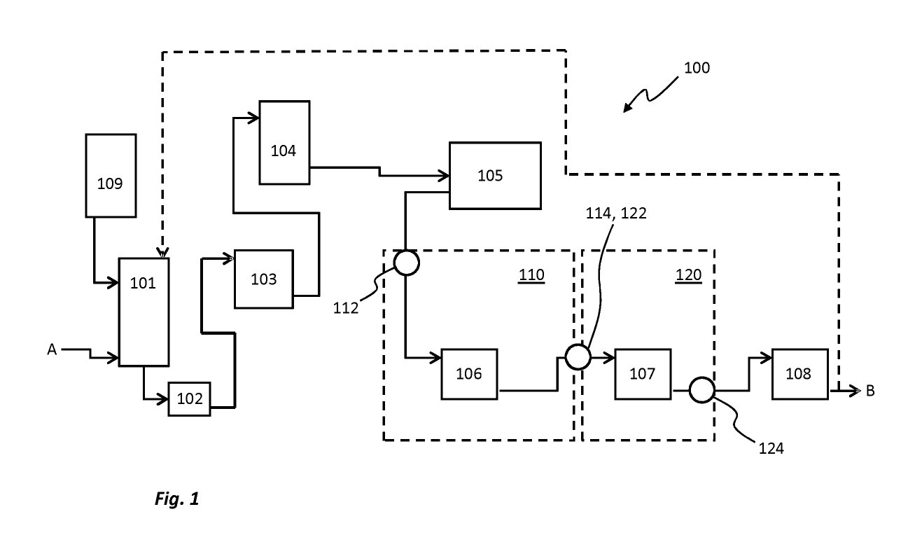

Now referring to FIG. 1, a process scheme describing an indirect UHT (ultra heat treatment) process system 10 of a milk dairy is shown. The process system 10 includes a number of sections each contributing to the treatment of the milk and further includes a CIP circuit 100 for cleaning the process system 10.

The milk to be treated is introduced at the left end of the figure, indicated by the reference “A”. The milk enters a balance tank 101 and is fed by means of a feed pump 102 to a preheater 103. The heated milk is thereafter transported to a deaerator 104 and a subsequently arranged homogenizer 105. Thereafter the milk passes through a first heater 106 and a second heater 107, whereafter the heated milk is cooled by a cooler 108 before it exit the processing system at the right end of the figure, indicated by reference “B”. A feeding tank 109 for cleaning detergents used for CIP is further connected to the balancing tank 101.

The first heater 106 forms part of a first heating section 110 which is designed to heat the milk product from approximately 70° to 95° C., wherein a subsequent heating section 120, including the second heater 107, is designed to heat the milk product from 95° to above 137° C. The choice of heating temperatures of the heating sections 110, 120 is dependent on the particular liquid product processing system, and may be adjusted according to the desired treatment of the liquid product. Hence, the above-mentioned temperatures are examples of one such system.

As is well known within dairy technology the first heating section 110 will mainly induce so called type-A fouling, which is a milk film consisting of 50-70% of proteins, 30-40% of minerals, and 4-8% of fat. The second heat section 120 will mainly induce so called type-B fouling, which is a milk stone consisting of approximately 15-20% of proteins, 70-80% of minerals, and 4-8% of fat. Generally, fouling occurs mostly in the heating sections 110, 120 which sections thus are most important to clean.

In a preferred embodiment the first section 110 is provided with two different pressure sensors 112, 114 arranged at the beginning and at the end, respectively, of the section 110. The pressure sensors 112, 114 may provide continuous measurements of the pressure difference over the section 110 during fouling build-up although their main functionality is to be activated upon CIP initiation for continuous monitoring of the cleaning process.

Correspondingly the second section 120 is as well provided with two pressure sensors 122, 124 arranged at the beginning and at the end, respectively, of the second section 120. Since the second section 120 is arranged directly after the first section 110 the first sensor 122 of the second section 120 may be the same as the second sensor 114 of the first section 110. However the sensors 122, 114 may also be provided as two separate sensors.

The pressure differences across the sections 110, 120 are determined as a difference between the second sensor 114, 124 and the first sensor 112, 122 of each section 110, 120. Alternatively, a pressure differential sensor may also be used for the same purpose.

When designing a CIP process at least five different flow steps may be considered, which is i) rinsing, ii) dosing of alkaline detergent, iii) circulation of alkaline detergent, iv) dosing of acid detergent, and v) circulation of acid detergent. Typically these steps are arranged in a sequence and optionally repeated in order to provide sufficient cleaning of the section.

As K_{syst} is dependent on temperature, density, and viscosity of the fluid

flowing through the equipment such constant must be determined for all five steps and for each section. Hence, for two sections 110 and 120 of which each is subject to five different cleaning steps ten different K_{syst} must be known.

The constants are preferably determined by using the equation above for a section which is considered as clean. By measuring the volume flow and the pressure difference for each particular cycle in a clean section values of the constant K_{syst} are easily obtained and stored in a reference memory.

When treasuring the pressure difference an absolute value is obtained. Since in most cases a relative value will provide sufficient information regarding the cleaning process a reference value is retrieved corresponding to the pressure difference of a section considered as sufficiently clean.

For this, volume flow sensors (not shown) are provided of which a measured volume flow is converted to a reference pressure difference by means of the system constant K_{syst}. According to the formula above, the reference pressure difference equals the square of the actual volume flow multiplied by the system constant. Since the volume flow is varying. It is preferred to calculate the reference pressure difference as a function of the measured volume flow. The system constant is determined by measuring the volume flow and the pressure difference across a clean section, whereby

$${K}_{syst} = \frac{Δ {P}_{o}}{{V}^{2}} .$$

It is thus necessary to determine the system constant for each cleaning step since the viscosity and the density of the cleaning agents differ from each other. When knowing the actual volume flow for a fouled section as well as the K_{syst} for the particular cleaning step the reference pressure difference of a clean section may be determined.

The measured pressure difference, i.e. the pressure difference determined directly by subtracting the pressure from the second sensor 114, 124 from the first sensor 112, 114, is then divided by the reference pressure difference whereby a pressure difference ratio is calculated. The calculated pressure difference ratio is larger than 1 for a fouled section, and equals 1 when the cleaning process is finished.

As an example, the following CIP process is determined for cleaning sections 110 and 120 alter a specific running time, whereby the treatment of milk during the running time, including heating of milk, is assumed to have caused fouling within the pipes of the equipment: i) rinsing, ii) dosing of alkaline detergent, iii) circulation of alkaline detergent, iv) rinsing, v) dosing of acid detergent, vi) circulation of acid detergent, and vii) rinsing.

The pressure difference across the first section 110 is measured continuously and divided by the calculated reference pressure difference for determining a variable pressure difference ratio. The calculated reference pressure difference is thus a function of the K_{syst} of the particular cycle as well as of the measured volume flew according to the formula above.

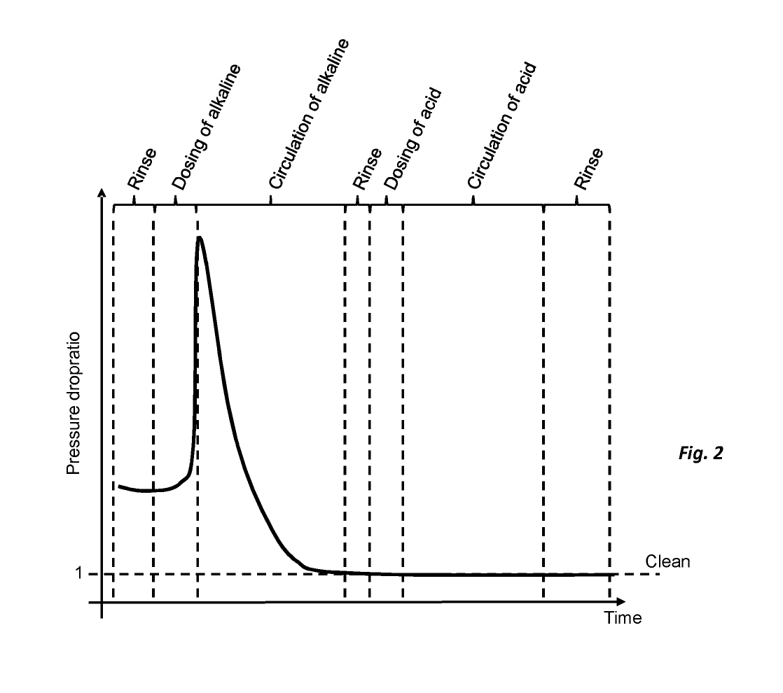

In FIG. 2 the pressure difference ratio of the first section 110 during a CIP cycle is illustrated as a function of time. The pressure difference ratio is larger than 1 at the beginning and is kept constant during the rinsing, initial rinsing is preferably performed directly after a purging step, whereby liquid food product still present within the system is recovered. After the initial rinsing step a subsequent step is initiated, in this case introduction of alkaline detergent. When alkaline detergent is introduced the pressure difference ratio increases due to swelling of the fouling in contact with the alkali after which it is effectively removed during step iii), i.e. circulation of alkaline detergent. The pressure difference ratio reaches 1, and the following steps of rinsing and flowing of acid detergent does not contribute to further fouling removal.

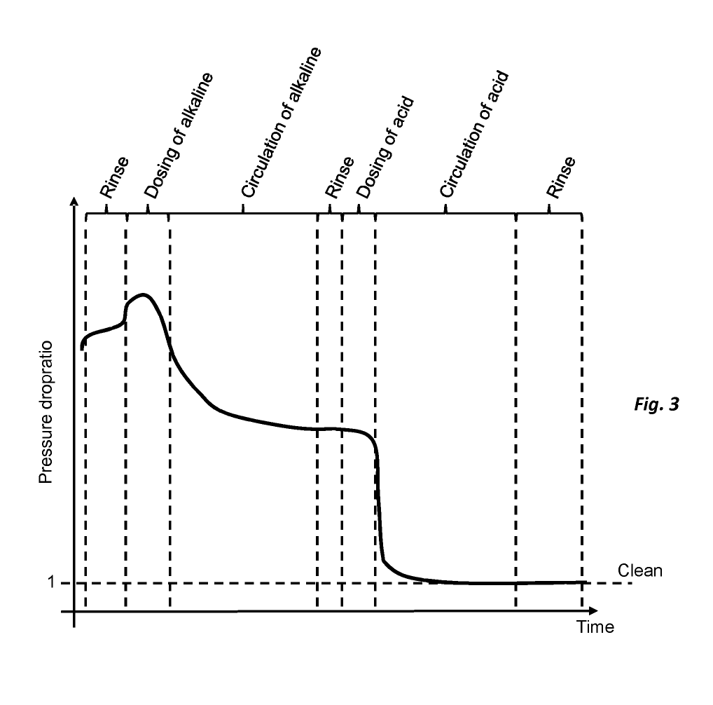

The cleaning of type-B fouling, i.e. fouling within the second section 120, follows another curve which is shown in FIG. 3. Upon introduction of alkaline detergent the pressure difference ratio increases for a short while whereafter it starts to decrease slowly. The decrease continues as alkaline detergent is circulated in the section 120, and reaches a steady state which is maintained during a subsequent rinsing step for removing the alkaline solution from the sections 110, 120. When dosing acid detergent the fouling starts to dissolve and the pressure difference ratio rapidly decreases to 1 during circulation of the acid detergent. A final rinsing step is performed in order to remove all chemicals enclosed within the CIP circuit, which otherwise may affect the subsequently introduced food product negatively.

The shown example thus represents a CIP process removing all fouling in the heaters 106, 107 of the dairy system, including the first and second heat sections 110, 120. As the pressure difference ratio is monitored continuously, it may be easy to detect any discrepancies from the normal behaviour of the CIP process, as well as it provides effective means for optimizing the CIP process.

Cleaning-in-place may be performed on an entire food processing system, i.e. as shown in FIG. 1 where cleaning detergents are introduced at the milk inlet A for cleaning ail food processing equipments within the system.

However, in other embodiments the entire food processing system may be divided into two or more CIP circuits, wherein the method of monitoring the CIP process is implemented for each CIP circuit. Each CIP circuit may further be divided into two or more subsections, wherein the pressure difference (or pressure difference ratio) is monitored continuously for each subsection.

Returning to FIG. 1, measuring the pressure difference across the first and second heating sections 110, 120 is advantageous since the CIP process affects the different sections 110, 120 differently. Consequently, the measured pressure differences may be used as input for optimizing the CIP process and will provide more information compared to if a single pressure difference across the heating sections 110, 120 was used.

Preferably, the measured pressure differences are used for optimizing the CIP process such that the sufficient cleaning is achieved with a minimum of used time and resources. The CIP step parameters which may be optimized are preferably detergent type (i.e. alkaline, acid or water), detergent concentration, detergent flow, duration, end temperature.

In the following, a method for pre-optimizing the CIP process will be described. In a first step, the process system to be cleaned is evaluated for determining the sections in which fouling is most likely to occur. This also includes the step of analyzing the type of food product being treated by the process system, as well as determining which kind of fouling such product will cause in the different sections. For example, milk is assumed to cause type-A fouling in a first heater, and type-B fouling in a subsequent heater. Further, it is assumed that the rest of the process system will be sufficiently cleaned if the fouled sections, being determined earlier, are cleaned.

As a next step the CIP is defined as a cleaning cycle of different step. The kind of steps which may be necessary for the CIP process are determined and normally includes the five steps previously described, i.e. rinsing, dosing of alkaline detergent, circulating alkaline detergent, dosing of acid detergent, and circulating acid detergent.

In a next method step reference values are obtained, which references values include i) the volume flow for each determined section when the section is considered as clean, i.e. when no or very little fouling is present within the equipment, and ii) system constants K_{syst} for each section and for each CIP cycle.

In order to pre-optimize the entire CIP process each section is preferably investigated individually, whereafter the CIP processes for each section are combined in order to obtain a complete CIP process for the entire CIP circuit.

When optimizing the cleaning for each section a theoretical approach may be beneficial, for reducing the number of experiments necessary. For example, it is well known that type-A fouling is removed efficiently by alkaline detergent, while it is more resistant to acid detergent. The reverse applies for type-B fouling.

However, the optimization may also be done by using the pressure sensors and calculating the pressure difference across each section during each CIP step. Hence, a reference table comprising information of how the pressure difference across a specific section is decreasing as a function of time, temperature, and agent flow may be determined for each CIP step. It should be noted that the pressure difference normally does not decrease linearly over time; in most cases the pressure difference decreases rapidly when the cycle starts, while the derivative of the pressure difference over time thereafter decreases. The reference table may preferably also store information of the pressure difference ratio, i.e. the measured pressure difference divided by the pressure difference of a clean section.

The pre-optimization of the entire CIP process may be done by deciding the necessary CIP steps, and in which order they should be performed. For example, it may be decided that each CIP process should start with a rinse step, and followed by dosing of alkaline, circulation of alkaline, rinsing, dosing of acid, circulation of acid, and a final rinsing step. Further details of the process, i.e. CIP step parameters, are determined as the CIP process is running. Such step parameters may for example be time, temperature, volume flow, and cleaning agent concentration of each specific CIP step.

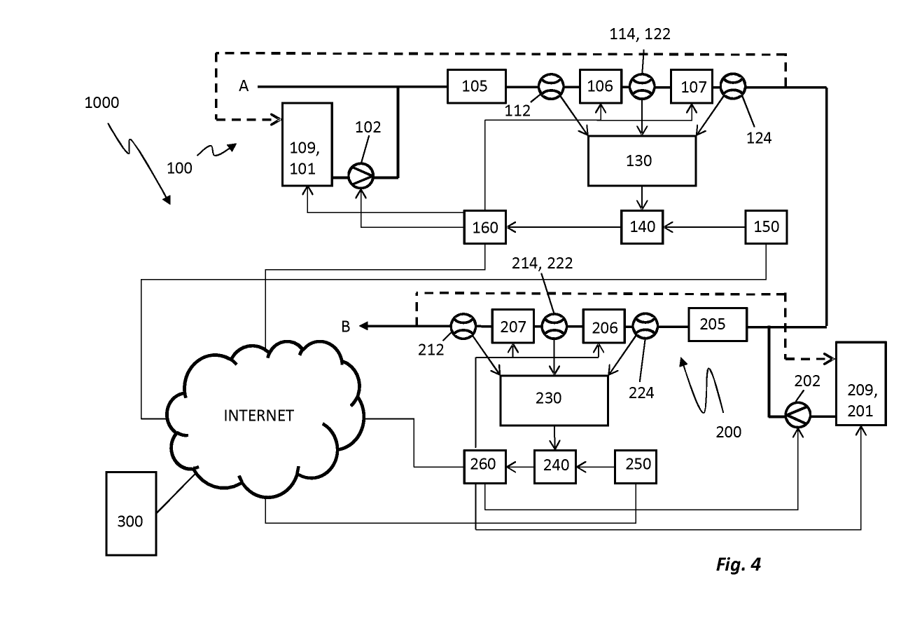

When CIP is initiated, the food product flow is diverted such that no more food product is introduced into the processing equipment to be clean; i.e. tanks, pipes, conduits, and other equipment are thus ready to receive cleaning liquids for removing the fouling. Normally, a rinsing step is performed in which water is fed through the system at a specific flow, temperature, and time. The pressure difference across the different sections is monitored continuously and divided with the reference value of a clean section to form a pressure difference ratio. As the sections are fouled, the pressure difference will initially be larger than 1. The pre-rinsing step is performed as long as food product may be recycled from the flow of rinsing water and food product; whereafter a first rinsing step of the CIP process is initiated. Now referring to FIG. 4, a food processing system 1000 is shown. The food processing system 1000 receives food product to be treated at the inlet “A”, and includes two different CIP circuits 100, 200. The first CIP circuit corresponds to the CIP circuit of the food processing system shown in FIG. 1, while the second CIP circuit 200 is arranged downstream of the first CIP circuit. The treated food product exits the food processing system 1000 at “B”, after passing the first and second CIP circuits 100, 200.

Starting with the first CIP circuit 100, the CIP inlet tank 109 is arranged to provide cleaning liquid via a feeding pump 102. Cleaning liquid is thus fed through the food processing equipment 105, such as a homogenizer or any other food processing equipment, before entering the heaters 106, and 107 respectively. As previously been described with reference to FIG. 1 pressure sensors 112, 114, 122, 124 are arranged to measure the actual pressure at different positions of the heaters 106 and 107. The measured values of the pressure are transmitted to a determining unit 130 which determines the pressure difference across the heaters 106, 107 by subtracting the upstream pressure from the downstream pressure.

The determined pressure differences for the different heaters 106, 107 are further transmitted to a calculator 140, in which the determined pressure differences are divided by a reference value fetched from a reference memory 150. The reference value corresponds to the pressure difference of a clean heater, and may be a measured value or a theoretical value. Further, the reference value may change over time, such that the reference value is updated according to different operation parameters of the food processing system, such as e.g. running time, change of liquid food product, etc. Preferably, a table of reference values are stored in a database.

The calculated pressure difference ratio is thereafter transmitted to a controller 160, which controller 160 is connected to the CIP inlet tank 109 for determining the cleaning liquid to be introduced into the CIP circuit, the feeding pump 102 for controlling the volume flow of the particular cleaning liquid, as well as to the heaters 106, 107 for controlling the temperature of the cleaning liquid at the respective heaters 106, 107. Further, the controller 160 is preferably also configured to control the duration time of a specific cleaning cycle.

As is further shown in FIG. 4, the reference memory 150 may be accessed from a remote server 300 via internet. The remote server 300 also stores reference data of optimized parameters of different cleaning steps, wherein the controller 160 is connected to the remote server 300 for providing the calculated pressure difference ratio, as well as for receiving optimized cleaning step parameters such as the choice of cleaning liquid, the volume flow, the temperature, as well as the duration of the cleaning step. For this purpose an optimisation algorithm may be provided on the remote server 300 such that the CIP circuit may be controlled in an efficient way.

As the food product passes the processing equipment 105, 106, 107 included in the first CIP circuit 100, additional processing equipment 205, 206, 207 is provided for further treatment of the food product. The equipment 205, 206, 207 may be any kind of processing equipment used in the food processing industry such as heaters, coolers, mixers, separators, filters etc. The additional equipment 205, 206, 207 are enclosed within the second CIP circuit 200, such as the second CIP circuit 200 is capable of cleaning said equipment including the removal of deposits such as fouling. For this, the second CIP circuit 200 includes a CIP inlet tank 209 arranged to provide cleaning liquid via a feeding pump 202. Cleaning liquid is thus fed through the food processing equipment 205 before entering the additional equipment 206, 207. Assuming that the equipment 206, 207 provides fouling pressure sensors 212, 214, 222, 224 are arranged to measure the pressure before and after each equipment 206, 207. The measured values of the pressure are transmitted to a determining unit 230 which determines the pressure difference across the equipments 206, 207 by subtracting the upstream pressure from the downstream pressure.

The determined pressure differences are further transmitted to a calculator 240, in which the determined pressure differences are divided by a reference value fetched from a reference memory 250. Also for the second CIP circuit, the reference value corresponds to the pressure difference of a clean equipment. The calculated pressure difference ratio is thereafter transmitted to a controller 260, which controller 260 is connected to the CIP inlet tank 209 for determining the cleaning liquid to be introduced into the CIP circuit, the feeding pump 202 for controlling the volume flow of the particular cleaning liquid, as well as to heaters (not shown) for controlling the temperature of the cleaning liquid at the respective equipment 206, 207. Further, the controller 260 is preferably also configured to control the duration time of a specific cleaning cycle.

The reference memory 250 may be accessed from the remote server 300 via internet. The remote server 300 also stores reference data of optimized parameters of different cleaning step, wherein the controller 260 is connected to the remote server 300 for providing the calculated pressure difference ratio, as well as for receiving optimized cleaning step parameters such as the choice of cleaning liquid, the volume flow, the temperature, as well as the duration of the cleaning step. For this purpose an optimisation algorithm may be provided on the remote server 300 such that the CIP circuit may be controlled in an efficient way.

Although the reference memories 150, 250 have been described as two separate components they may be included in a single memory. The same applies for the controllers 160, 260.

As described above, a method for monitoring fouling of at least one section of a food processing system has been described. The method is preferably implemented for determining a pressure difference ratio by dividing an actual pressure difference with a reference pressure difference, which reference pressure difference is obtained by multiplying a volume flow through a clean section with a system constant.

A section may be an entire food processing equipment, or a part thereof. For example, a heater may be divided into several sections, such that a pressure difference is measured for each section of the heater.

The reference flow meter may further be arranged somewhere in the food processing system, however it is preferred to arrange the volume flow meter close to a section across which a pressure difference is measured.

The invention has mainly been described with reference to a few embodiments. However, as is readily understood by a person skilled in the art, other embodiments than the ones disclosed above are equally possible within the scope of the invention, as defined by the appended claims.

1. A method for monitoring the operation of a liquid food processing system, comprising:
initiating a fluid flow through at least one section of said food processing system; and
determining a pressure difference across said at least one section during said fluid flow for monitoring removal or build-up of deposits, said removal or build-up being caused by said fluid flow.

2. The method according to claim 1, further comprising comparing said determined pressure difference with a reference value.

3. The method according to claim 2, further comprising dividing said determined pressure difference with said reference value for calculating a pressure difference ratio.

4. The method according to claim 2, wherein said reference value represents the pressure difference across said section when said section is considered as being sufficiently clean.

5. The method according to claim 1, wherein said pressure difference is determined continuously during said fluid flow.

6. The method according to claim 5, wherein said determined pressure difference comprises a value representing the pressure difference derivative, and wherein the method further comprises comparing said value with a pressure difference reference derivative.

7. The method according to claim 1, wherein the pressure difference reference value is calculated by measuring a volume flow of a fluid flow through said section when being sufficiently clean, and multiplying the square of said volume flow with a predetermined constant.

8. The method according to claim 1, further comprising dividing said liquid food processing system into at least two sections, wherein said pressure difference is determined across each section during said fluid flow.

9. A method for optimizing the operation of a liquid food processing system, comprising:
monitoring said operation according to claim 1, and
stopping said fluid flow when the determined pressure difference equals a predetermined value.

10. The method according to claim 9, wherein said fluid flow is provided by initiating a cleaning step including flowing a cleaning agent through a cleaning-in-place circuit of said liquid food processing system, wherein the method further comprises changing at least one cleaning step parameter during said cleaning step.

11. The method according to claim 10, wherein said at least one cleaning step parameter is selected from the group consisting of: cleaning step duration, cleaning agent temperature, cleaning agent flow, and cleaning agent concentration.

12. The method according to claim 10, further comprising initiating a subsequent cleaning step after stopping the monitored cleaning step.

13. The method according to claim 12, wherein said subsequent cleaning step is a rinsing step, a dosing of alkaline detergent step, a circulation of alkaline detergent step, a dosing of acid detergent step, or a circulation of acid detergent step.

14. The method according to claim 12, wherein the method of monitoring said operation is repeated for said subsequent cleaning step.

15. The method according to claim 9, wherein said fluid flow is provided by initiating a liquid product flow through said liquid food processing system, wherein the method further comprises changing at least one product flow parameter during said product flow.

16. The method according to claim 15, further comprising initiating a rinsing step after stopping the monitored liquid product flow.

17. The method according to claim 16, further comprising initiating a cleaning-in-place cycle after said rinsing step.

18. The method according to claim 9, further comprising identifying the product being processed by said liquid food processing system, and wherein said predetermined value of the pressure difference is associated with said product.

19. The method according to claim 9, wherein said liquid food processing system is a dairy system.

20. A liquid food processing system comprising:
at least one section through which liquid food products are flowing during food processing and causing build-up of deposits within said section, and
at feast one sensor configured to determine a pressure difference across said at least one section for monitoring removal or build-up of said deposits.

21. The food processing system according to claim 20, wherein said at least one sensor includes two sensors arranged at a first end and a second end of said section.

22. The food processing system according to claim 20, further comprising a determining unit connected to said sensors and being configured to calculate said pressure difference.

23. The food processing system according to claim 20, further comprising a calculating unit configured to receive said determined pressure difference and to compare said pressure difference with a reference value.

24. The food processing system according to claim 20, further comprising a cleaning-in-place circuit for removing said deposits by initiating a cleaning cycle including at least one step of flowing cleaning fluid through said at least one section.

25. The food processing system according to claim 24, further comprising a controller configured to receive said determined pressure difference, wherein said controller is further connected to a pump and/or heating units of said sections and/or a feeding tank for changing the operating parameters of said pump and/or said heating units depending of the received pressure difference.

26. The food processing system according to claim 25, wherein said controller is connected to a remote reference memory storing data representing said operating parameters as a function of pressure difference.

27. The food processing plant according to claim 26, wherein said remote reference memory is connected to several food processing systems such that each processing system receives data representing said operating parameters from said reference memory.

28. A kit of parts for installation in a liquid food processing plant, comprising:
a volume flow sensor for measuring a volume flow of a reference fluid flow,
a calculator for determining a reference pressure difference from said measured volume flow,
a pressure difference sensor for measuring a pressure difference of an actual fluid flow, and
a controller for comparing said measured pressure difference with said reference pressure difference for monitoring removal or build-up of deposits during said actual fluid flow.
